(19) United States
(12) Patent Application Publication
(10) Pub. No.: US 2026/0227652 A1
(43) Pub. Date: Aug. 6, 2026

(54) ELECTRO-OPTICAL DEVICE WITH SILICON-RICH NITRIDE WAVEGUIDE AND LITHIUM NIOBATE LAYER

(71) Applicant: DustPhotonics, Modiin (IL)

(72) Inventors: Yoel Chetrit, Kfar Ben Nun (IL); Moshe Zadka, Jerusalem (IL); Alex Naiman, Tel Aviv (IL)

(73) Assignee: DustPhotonics, Modiin (IL)

(21) Appl. No.: 19/459,102

(22) Filed: Jan. 26, 2026

Related U.S. Application Data
(60) Provisional application No. 63/749,642, filed on Jan. 26, 2025.

(51) Int. Cl. G02F 1/035

(52) U.S. Cl. CPC G02F 1/035; G02F 2202/20

(57) ABSTRACT

An electro-optical device comprises a first item including a lithium niobate layer and a second item bonded to the first item. The second item includes a first electrode and a second electrode spaced apart from each other, a silicon-rich nitride waveguide positioned between the first electrode and the second electrode and adjacent to the lithium niobate layer, and a silicon dioxide region surrounding the first electrode, the second electrode, and the silicon-rich nitride waveguide. The silicon-rich nitride waveguide is configured to support a hybrid optical mode residing in both the silicon-rich nitride waveguide and the lithium niobate layer. The first electrode and the second electrode are configured to generate an electric field that modulates an optical property of the lithium niobate layer.

### CROSS-REFERENCE TO RELATED APPLICATIONS

This application claims priority to U.S. Provisional Application No. 63/749,642, filed Jan. 26, 2025 which is hereby incorporated by reference in its entirety.

### FIELD OF INVENTION

The present disclosure relates to electro-optical devices and fabrication methods thereof, and more particularly to an electro-optical device comprising a silicon-rich nitride waveguide bonded to a lithium niobate layer for optical modulation using CMOS compliant manufacturing processes.

### BACKGROUND

Electro-optical modulators are devices that modulate optical signals using electric fields applied to materials exhibiting electro-optic effects. Lithium niobate is a material that exhibits strong electro-optic properties, making it suitable for use in optical modulators. The integration of lithium niobate with silicon photonics platforms has attracted interest due to the potential for combining the electro-optic properties of lithium niobate with the manufacturing capabilities of silicon-based fabrication processes.

In electro-optical applications, the positioning of metal traces relative to the optical mode in the electro-optically active material affects device performance. Metal traces positioned in close proximity to the optical mode can provide efficient electric field application to the electro-optic material. However, bringing metal traces closer to the optical mode may increase optical propagation losses if the waveguide material does not provide sufficient optical confinement.

Fabricating lithium niobate in CMOS manufacturing facilities may lead to contamination.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, an electro-optical device is provided. The electro-optical device comprises a first item including a lithium niobate layer. The electro-optical device further comprises a second item bonded to the first item. The second item includes a first electrode and a second electrode spaced apart from each other. The second item includes a silicon-rich nitride waveguide positioned between the first electrode and the second electrode and adjacent to the lithium niobate layer. The second item includes a silicon dioxide region surrounding the first electrode, the second electrode, and the silicon-rich nitride waveguide. The silicon-rich nitride waveguide is configured to support a hybrid optical mode residing in both the silicon-rich nitride waveguide and the lithium niobate layer.

The first electrode and the second electrode are configured to generate an electric field that modulates an optical property of the lithium niobate layer.

According to other aspects of the present disclosure, the electro-optical device may include one or more of the following features. The first electrode and the second electrode may comprise copper. The second item may further comprise a first aluminum electrode electrically coupled to the first electrode and a second aluminum electrode electrically coupled to the second electrode. The first aluminum electrode and the second aluminum electrode may be positioned at a bottom portion of the second item. The first item may further comprise a first item substrate and a buried oxide layer disposed between the first item substrate and the lithium niobate layer. The second item may further comprise a second item substrate positioned below the silicon dioxide region. The second item substrate may comprise a high resistance silicon substrate. The second item may further comprise a CMOS compliant sub-item disposed within the silicon dioxide region. The CMOS compliant sub-item may include a first silicon region, a second silicon region, a germanium region, a silicon nitride region, a titanium nitride region, a first metal layer region, a second metal layer region, and a third metal layer region. The second item may further comprise a first via connecting the first electrode to the first metal layer region, a second via connecting the first metal layer region to the second metal layer region, and a third via connecting the second metal layer region to the third metal layer region. The germanium region may be configured for optical sensing.

The titanium nitride region may be configured as a resistor or a heater.

According to another aspect of the present disclosure, a method for fabricating an electro-optical device is provided. The method comprises providing a CMOS compliant structure including a first electrode and a second electrode spaced apart from each other within a silicon dioxide region. The method comprises forming a silicon-rich nitride waveguide on the silicon dioxide region between the first electrode and the second electrode. The method comprises bonding a first item including a lithium niobate layer to the silicon dioxide region such that the lithium niobate layer is positioned adjacent to the silicon-rich nitride waveguide.

According to other aspects of the present disclosure, the method may include one or more of the following features. Providing the CMOS compliant structure may comprise depositing a patterned CMP stop layer on a silicon dioxide layer, etching the silicon dioxide layer to form a first inner space and a second inner space, depositing copper to form the first electrode in the first inner space and the second electrode in the second inner space, and removing the patterned CMP stop layer. The method may further comprise depositing an oxide layer to encapsulate the first electrode and the second electrode, forming a first aluminum electrode electrically coupled to the first electrode, and forming a second aluminum electrode electrically coupled to the second electrode.

The method may further comprise bonding a second item substrate to an upper surface of the oxide layer, flipping the CMOS compliant structure, and removing an initial substrate from the CMOS compliant structure prior to forming the silicon-rich nitride waveguide. Forming the silicon-rich nitride waveguide may comprise depositing a silicon-rich nitride layer and patterning and etching the silicon-rich nitride layer.

According to another aspect of the present disclosure, a method for operating an electro-optical device is provided. The method comprises providing an electro-optical device including a first item having a lithium niobate layer bonded to a second item having a first electrode, a second electrode, and a silicon-rich nitride waveguide positioned between the first electrode and the second electrode and adjacent to the lithium niobate layer. The method comprises propagating an optical signal through a hybrid optical mode residing in both the silicon-rich nitride waveguide and the lithium niobate layer. The method comprises applying an RF signal to the first electrode and the second electrode to generate an electric field that modulates an optical property of the lithium niobate layer, thereby modulating the optical signal.

According to other aspects of the present disclosure, the method for operating the electro-optical device may include one or more of the following features. The second item may further comprise a first aluminum electrode electrically coupled to the first electrode and a second aluminum electrode electrically coupled to the second electrode, and the RF signal may be applied through the first aluminum electrode and the second aluminum electrode. The first aluminum electrode and the second aluminum electrode may be positioned at a bottom portion of the second item. The silicon-rich nitride waveguide may have a refractive index higher than stoichiometric silicon nitride, thereby providing higher optical confinement and allowing closer positioning of the first electrode and the second electrode to the silicon-rich nitride waveguide without increasing optical propagation loss.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1A illustrates a cross-sectional view of an electro-optical device comprising a first item bonded to a second item, according to aspects of the present disclosure.

FIG. 1B illustrates a cross-sectional view of an electro-optical device comprising a first item bonded to a second item, according to an embodiment.

FIG. 1C illustrates a cross-sectional view of an electro-optical device showing electrodes and a field between them, according to aspects of the present disclosure.

FIG. 1D illustrates a cross-sectional view of an electro-optical device showing internal components and interconnections, according to an embodiment.

FIG. 2A illustrates a cross-sectional view of a CMOS compliant structure on an initial substrate, according to aspects of the present disclosure.

FIG. 2B illustrates a cross-sectional view of a structure during a fabrication phase with inner spaces formed, according to an embodiment.

FIG. 2C illustrates a cross-sectional view of a structure with electrodes formed in the inner spaces of FIG. 2B, according to aspects of the present disclosure.

FIG. 2D illustrates a cross-sectional view of a CMOS compliant structure with electrodes, according to an embodiment.

FIG. 2E illustrates a cross-sectional view of a CMOS compliant structure with electrodes and metal layer regions, according to aspects of the present disclosure.

FIG. 2F illustrates a cross-sectional view of a second sub-item structure on an initial substrate, according to an embodiment.

FIG. 2G illustrates a cross-sectional view of a CMOS compliant structure with electrodes and functional regions, according to aspects of the present disclosure.

FIG. 2H illustrates a cross-sectional view of a CMOS compliant structure with electrodes and metal interconnects, according to an embodiment.

FIG. 2I illustrates a cross-sectional view of a CMOS compliant structure with electrodes and via connections, according to aspects of the present disclosure.

FIG. 2J illustrates a cross-sectional view of a second item during a manufacturing stage, according to an embodiment.

FIG. 2K illustrates a cross-sectional view of a second item structure with a waveguide and electrodes, according to aspects of the present disclosure.

FIG. 2L illustrates a cross-sectional view of a second item structure showing internal arrangement of components, according to an embodiment.

FIG. 2M illustrates a cross-sectional view of a second item structure with a waveguide and aluminum electrodes, according to aspects of the present disclosure.

FIG. 3A illustrates a flowchart for a method of fabricating an electro-optical device, according to an embodiment.

FIG. 3B illustrates a flowchart for a method of operating an electro-optical device, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Silicon nitride waveguides have been used in photonic integrated circuits due to their compatibility with CMOS fabrication processes and their optical properties.

Stoichiometric silicon nitride has a particular refractive index that determines the degree of optical confinement achievable in waveguides formed from this material. The degree of optical confinement affects how closely metal electrodes can be positioned to the waveguide without introducing unacceptable optical losses.

Standard silicon photonics fabrication processes typically provide electrical contact to external circuits via the topmost metal layer of the device structure. This approach may impose requirements on oxide planarization before bonding additional layers to the device. The sequence of fabrication steps and the manner in which different materials are integrated can affect both the manufacturing complexity and the performance characteristics of the resulting device.

Hybrid optical modes, in which the optical field resides in multiple material layers simultaneously, can be supported by appropriate waveguide structures. Such hybrid modes may enable interaction between the optical field and electro-optic materials while maintaining waveguiding functionality. The design of structures supporting hybrid modes involves considerations of material refractive indices, layer thicknesses, and geometric arrangements. An example of a hybrid mode is illustrated in US patent application Ser. No. 18/860,678, titled ELECTCRO-OPTIC MODULATOR AND A METHOD FOR FABRICATING THE ELECTRO-OPTIC MODULATOR, which is incorporated herein by reference.

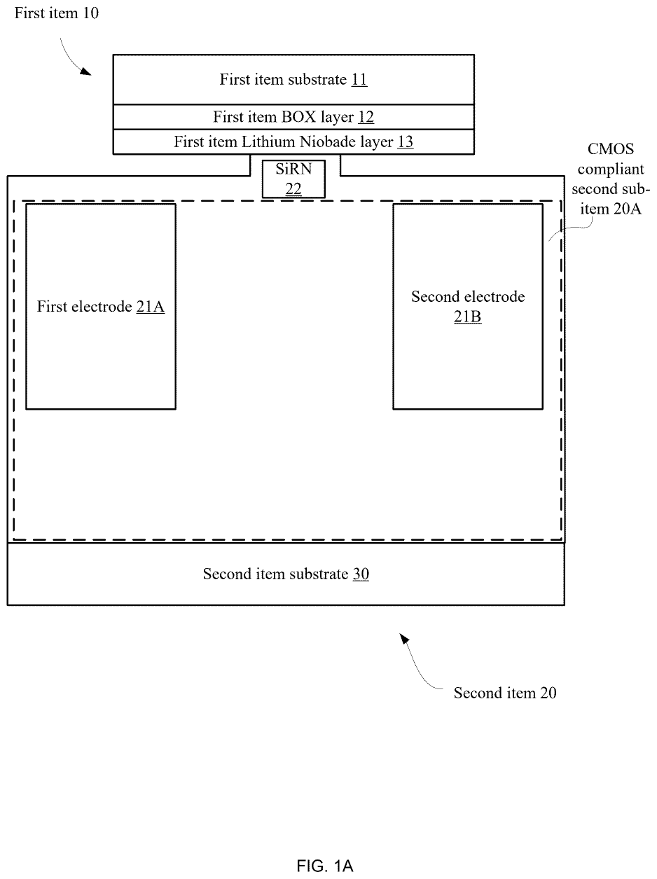

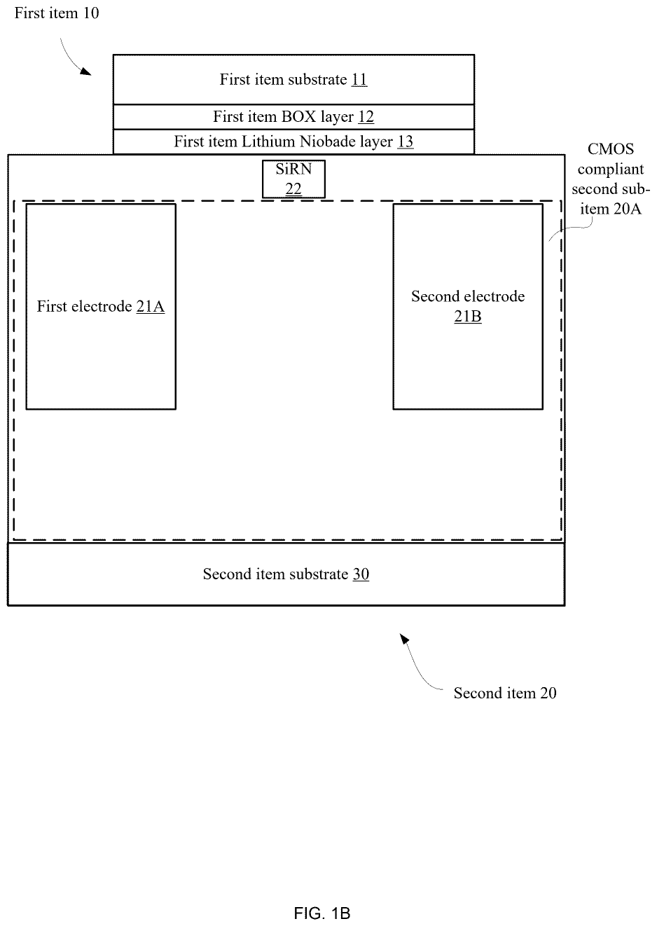

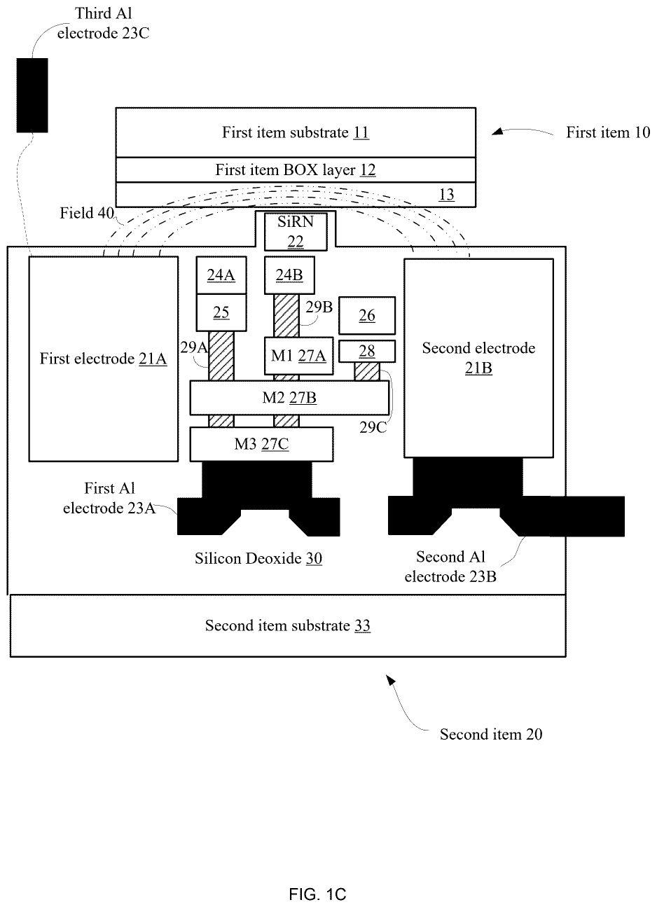

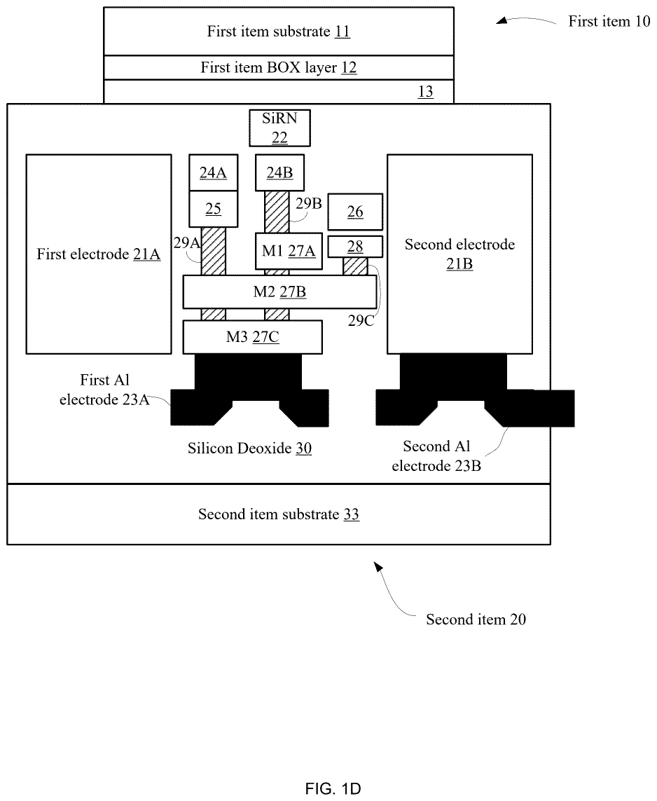

Referring to FIG. 1A, an electro-optical device may comprise a first item 10 bonded to a second item 20. The first item 10 may include a first item substrate 11, a first item BOX layer 12 disposed beneath the first item substrate 11, and a first item lithium niobate layer 13 positioned below the first item BOX layer 12. The first item lithium niobate layer 13 may serve as an electrooptically active material in the electro-optical device. The first item BOX layer 12 may be disposed between the first item substrate 11 and the first item lithium niobate layer 13.

With continued reference to FIG. 1A, the second item 20 may be bonded to the first item 10 and may include a CMOS compliant second sub-item 20A. The CMOS compliant second sub-item 20A may encompass components manufactured using a CMOS compliant manufacturing process. The second item 20 may include a first electrode 21A and a second electrode 21B spaced apart from each other. The first electrode 21A may be positioned on one side of the second item 20, and the second electrode 21B may be positioned on an opposite side of the second item 20.

A SiRN waveguide 22 may be positioned between the first electrode 21A and the second electrode 21B and adjacent to the first item lithium niobate layer 13. The SiRN waveguide 22 may comprise silicon-rich nitride material. The second item 20 may further include a silicon dioxide 30 region surrounding the first electrode 21A, the second electrode 21B, and the SiRN waveguide 22. The silicon dioxide 30 may form a dielectric material that encapsulates the electrodes and other components within the second item 20.

As further shown in FIG. 1A, the SiRN waveguide 22 may be configured to support a hybrid optical mode residing in both the SiRN waveguide 22 and the first item lithium niobate layer 13. The first electrode 21A and the second electrode 21B may be configured to generate an electric field that modulates an optical property of the first item lithium niobate layer 13. When the first electrode 21A and the second electrode 21B are biased, the electric field generated between the electrodes may impact the optical properties of the first item lithium niobate layer 13, thereby enabling optical modulation through the electro-optic effect.

In some cases, an air gap may be present at both sides of the SiRN waveguide 22 and between the first item 10 and an upper part of the second item 20 located to the sides of the SiRN waveguide 22. The air gap may provide optical isolation and may reduce optical losses in the electro-optical device. The bonding of the first item 10 to the second item 20 may position the electrooptically active material as a final step in a fabrication process, which may eliminate a need for post-processing after the first item lithium niobate layer 13 is attached to the second item 20.

Referring to FIG. 1B, an alternative embodiment of the electro-optical device may comprise a first item 10 bonded to a second item 20, where a top part of the first item 10 is planar. In this configuration, no air gap may be present between the first item 10 and the second item 20. The first item 10 may include a first item substrate 11 positioned at a top portion of the structure, a first item BOX layer 12 disposed beneath the first item substrate 11, and a first item lithium niobate layer 13 positioned below the first item BOX layer 12. The first item lithium niobate layer 13 may interface directly with the second item 20 at a bonding region without an intervening air gap.

With continued reference to FIG. 1B, the second item 20 may be positioned below the first item 10 and may include a CMOS compliant second sub-item 20A. The CMOS compliant second sub-item 20A may encompass components manufactured using a CMOS compliant manufacturing process. Within the CMOS compliant second sub-item 20A, a first electrode 21A may be positioned on one side and a second electrode 21B may be positioned on an opposite side, with the first electrode 21A and the second electrode 21B being spaced apart from one another.

A SiRN waveguide 22 may be located between and above the first electrode 21A and the second electrode 21B, positioned adjacent to the first item lithium niobate layer 13. The SiRN waveguide 22 may support a hybrid optical mode that resides in both the SiRN waveguide 22 and the first item lithium niobate layer 13. The second item 20 may further include silicon dioxide 30, which may form a dielectric material surrounding the first electrode 21A, the second electrode 21B, and other components within the structure. When the electro-optical device is operated, biasing the first electrode 21A and the second electrode 21B may generate an electric field that impacts optical properties of the first item lithium niobate layer 13, thereby enabling optical modulation through the electro-optic effect. The planar configuration of the top part of the first item 10 may provide direct contact between the first item lithium niobate layer 13 and the silicon dioxide 30 of the second item 20 across the bonding interface.

Referring to FIG. 1C, a detailed cross-sectional view of the electro-optical device illustrates the arrangement of the first electrode 21A and the second electrode 21B with a field 40 generated between the first electrode 21A and the second electrode 21B. The first electrode 21A and the second electrode 21B may comprise copper. The field 40 may be established when the first electrode 21A and the second electrode 21B are biased, and the field 40 may influence the optical properties of the first item lithium niobate layer 13 to enable optical modulation.

With continued reference to FIG. 1C, the second item 20 may further comprise a first aluminum electrode 23A electrically coupled to the first electrode 21A, a second aluminum electrode 23B electrically coupled to the second electrode 21B, and a third aluminum electrode 23C. The first aluminum electrode 23A and the second aluminum electrode 23B may be positioned at a bottom portion of the second item 20.

The third aluminum electrode 23C may be located outside an area of the cross-sectional view and may provide additional electrical connection capability. Electrical connection to an external world may be done via a bottom-most metal layer rather than a topmost metal layer, which may ease a requirement for top oxide planarization before bonding.

As further shown in FIG. 1C, the second item 20 may further comprise a CMOS compliant sub-item disposed within the silicon dioxide 30 region. The CMOS compliant sub-item may include a first silicon region 24A, a second silicon region 24B, a germanium region 25, a SiN region 26, a TiN region 28, a first metal layer region 27A, a second metal layer region 27B, and a third metal layer region 27C. The first silicon region 24A may be positioned beneath the first electrode 21A, and the second silicon region 24B may be positioned adjacent to the SiRN waveguide 22. The germanium region 25 may be located below the first silicon region 24A. The SiN region 26 and the TiN region 28 may be positioned in a central portion of the structure beneath the second silicon region 24B.

The germanium region 25 may be configured for optical sensing. The TiN region 28 may be configured as a resistor or a heater. Any of the first silicon region 24A, the second silicon region 24B, the germanium region 25, the SiN region 26, and the TiN region 28 may be with or without doping.

With continued reference to FIG. 1C, the first metal layer region 27A may be labeled M1 and may be positioned above the germanium region 25. The second metal layer region 27B may be labeled M2 and may be positioned below the first metal layer region 27A. The third metal layer region 27C may be labeled M3 and may be located at a lowest level of a metal stack. The first metal layer region 27A, the second metal layer region 27B, and the third metal layer region 27C may be arranged vertically within the silicon dioxide 30.

The second item 20 may further comprise a first via 29A, a second via 29B, and a third via 29C providing connectivity between the various layers. The first via 29A may connect the first electrode 21A to the first metal layer region 27A. The second via 29B may connect the first metal layer region 27A to the second metal layer region 27B. The third via 29C may connect the second metal layer region 27B to the third metal layer region 27C. The first via 29A, the second via 29B, and the third via 29C may provide electrical pathways through the structure.

As further shown in FIG. 1C, a second item substrate 33 may be positioned at a bottom of the second item 20. The second item substrate 33 may support the silicon dioxide 30 and the first aluminum electrode 23A and the second aluminum electrode 23B. The second item substrate 33 may comprise a high resistance silicon substrate.

The use of silicon-rich nitride material in the SiRN waveguide 22, which may have a refractive index higher than stoichiometric silicon nitride, may facilitate higher optical confinement and may allow closer positioning of metal traces to the SiRN waveguide 22 without increasing optical propagation loss. The arrangement of the first electrode 21A and the second electrode 21B in close proximity to the SiRN waveguide 22 may enable efficient electro-optical modulation while maintaining low optical losses.

Referring to FIG. 1D, the electro-optical device may comprise a first item 10 bonded to a second item 20. The first item 10 may include a first item substrate 11 positioned at a top portion of the structure. A first item BOX layer 12 may be disposed beneath the first item substrate 11. The first item BOX layer 12 may function as a buried oxide layer disposed between the first item substrate 11 and a first item lithium niobate layer 13. The first item lithium niobate layer 13 may be positioned below the first item BOX layer 12 and may interface with the second item 20.

With continued reference to FIG. 1D, the second item 20 may include a SiRN waveguide 22 positioned centrally and in contact with the first item lithium niobate layer 13. The SiRN waveguide 22 may be flanked by a first electrode 21A on one side and a second electrode 21B on an opposite side. The first electrode 21A and the second electrode 21B may be spaced apart from the SiRN waveguide 22.

Below the SiRN waveguide 22, the second item 20 may contain a first silicon region 24A and a second silicon region 24B positioned in an upper portion of a silicon dioxide 30 region. A germanium region 25 may be located adjacent to the first silicon region 24A. A SiN region 26 may be positioned near the second silicon region 24B. A TiN region 28 may be located between the SiN region 26 and a first metal layer region 27A. The first silicon region 24A, the second silicon region 24B, the germanium region 25, the SiN region 26, and the TiN region 28 may be with or without doping.

As further shown in FIG. 1D, the second item 20 may include multiple metal layer regions arranged vertically. The first metal layer region 27A may be connected to a second metal layer region 27B below the first metal layer region 27A, which in turn may connect to a third metal layer region 27C. The first metal layer region 27A, the second metal layer region 27B, and the third metal layer region 27C may be with or without doping.

The second item 20 may further comprise a first via 29A connecting the first electrode 21A to the first metal layer region 27A. A second via 29B may connect the first metal layer region 27A to the second metal layer region 27B. A third via 29C may connect the second metal layer region 27B to the third metal layer region 27C. The first via 29A, the second via 29B, and the third via 29C may provide electrical connectivity between the different layers and may be with or without doping.

With continued reference to FIG. 1D, at a bottom of the silicon dioxide 30 region, a first aluminum electrode 23A may be connected to the first electrode 21A, and a second aluminum electrode 23B may be connected to the third metal layer region 27C. A second item substrate 33 may be positioned below the silicon dioxide 30 region, supporting the silicon dioxide 30 and the first aluminum electrode 23A and the second aluminum electrode 23B. The second item substrate 33 may comprise a high resistance silicon substrate.

Electrical connection may be done from a bottom of the electro-optical device by use of a through silicon via (TSV) reaching the first aluminum electrode 23A or the second aluminum electrode 23B. The arrangement may enable electrical connections between the electrodes and the metal layer regions while positioning the SiRN waveguide 22 in proximity to the first item lithium niobate layer 13 for electro-optical modulation.

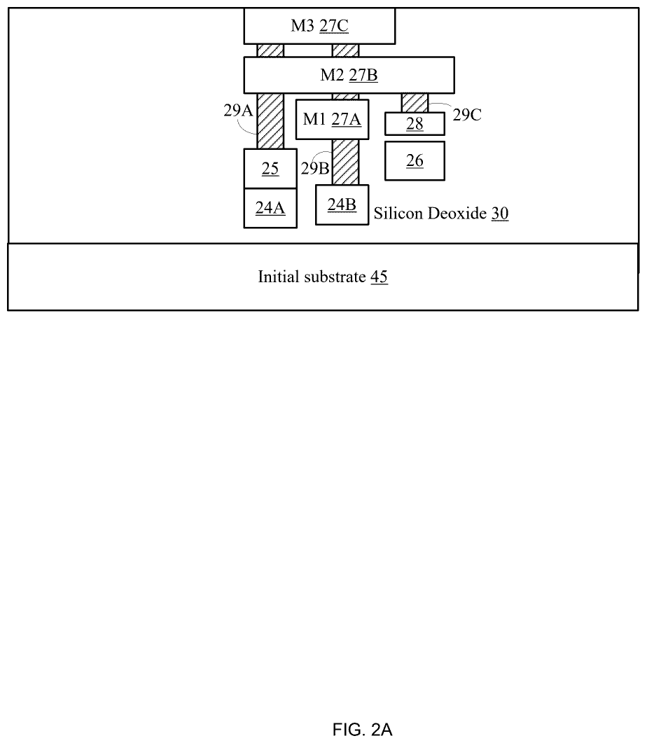

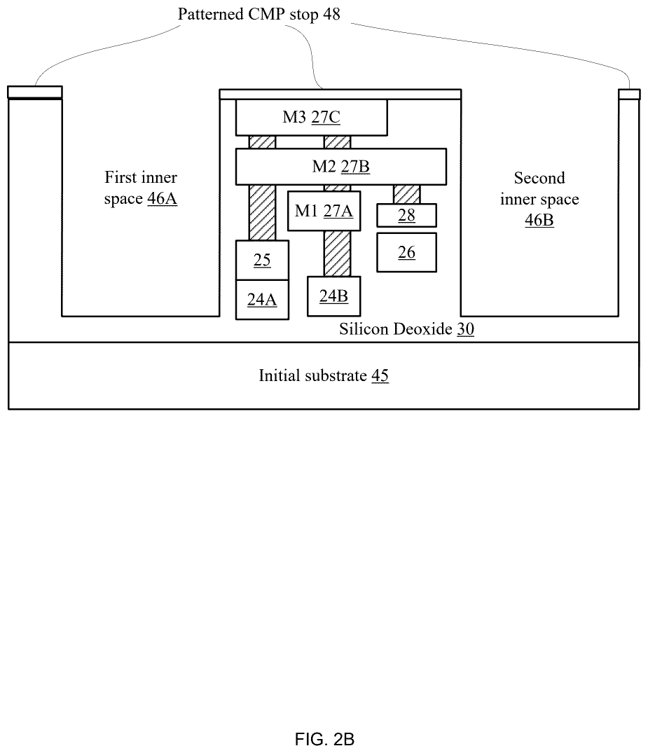

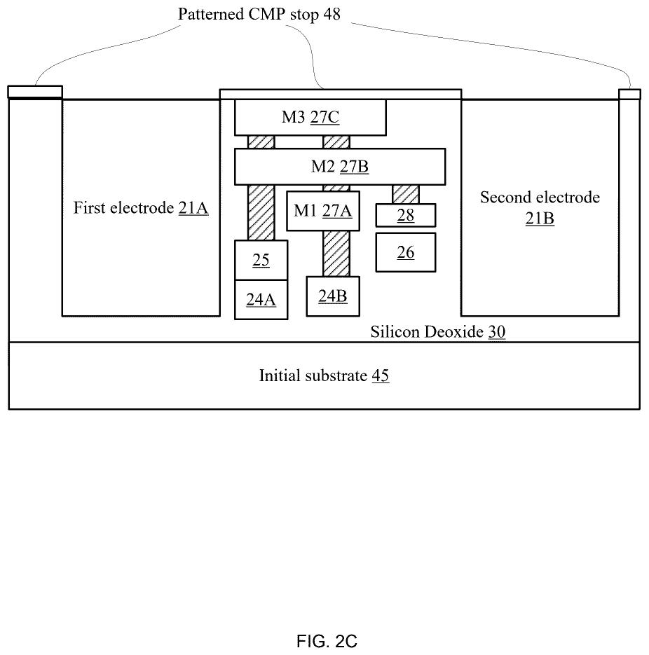

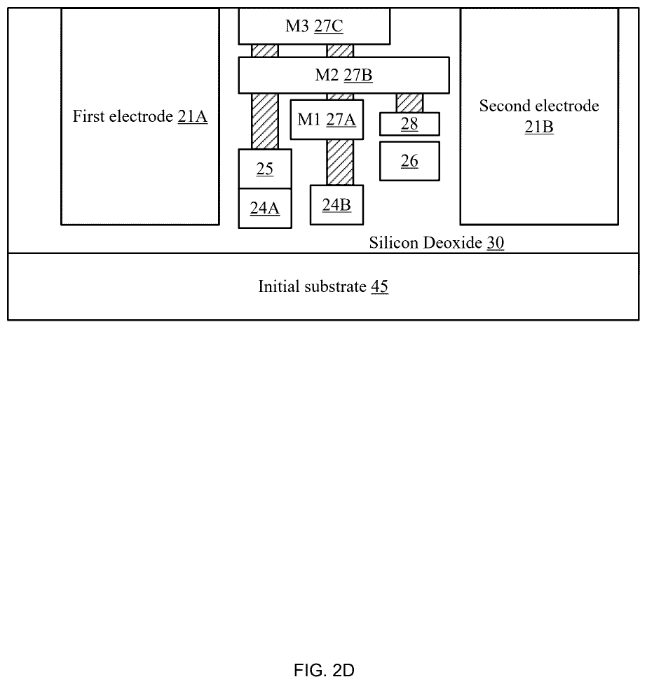

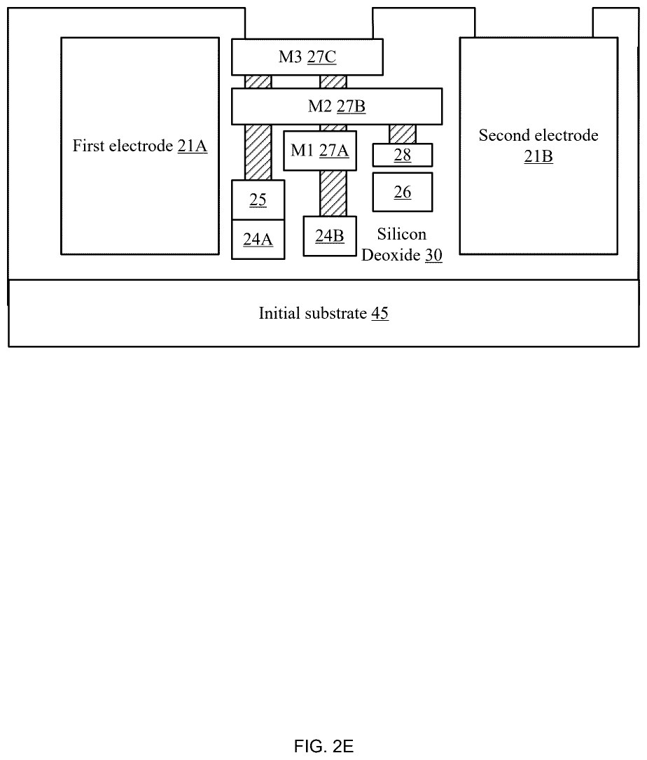

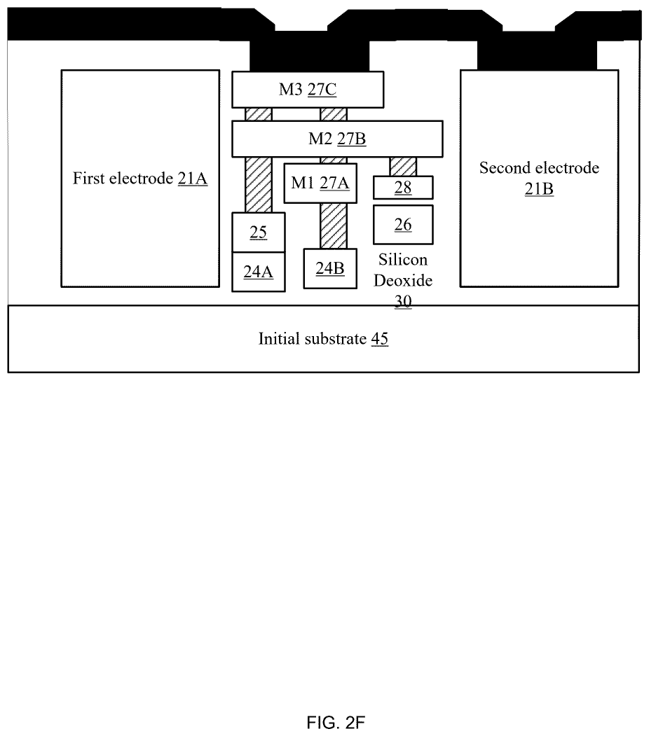

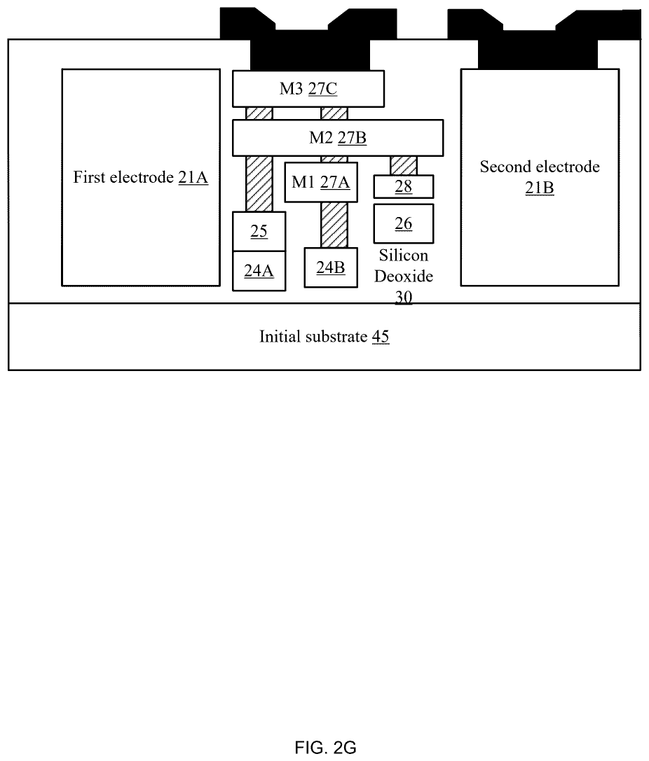

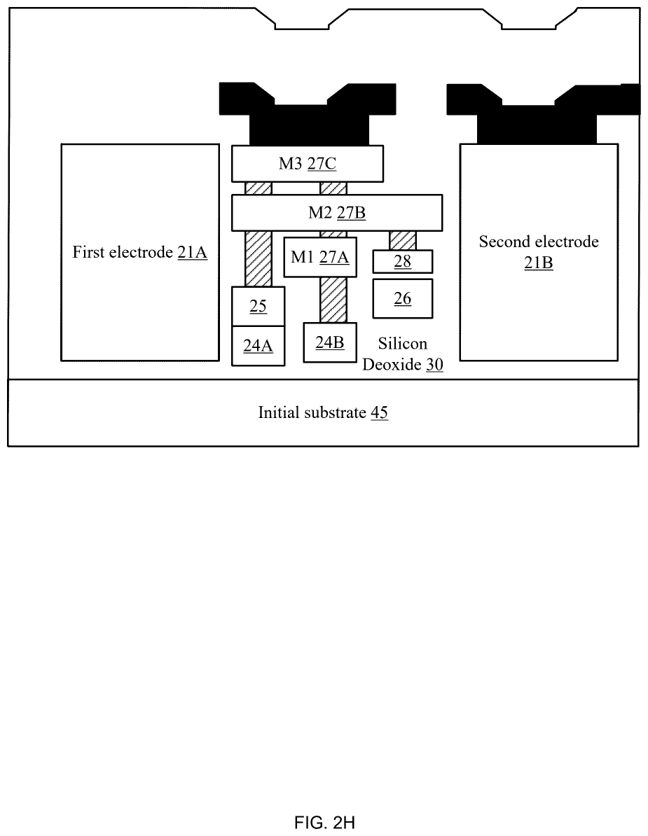

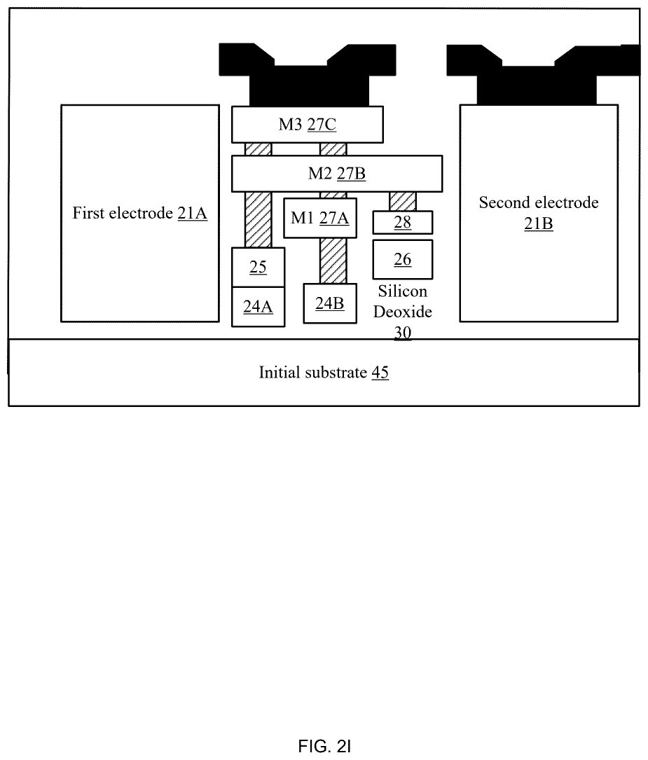

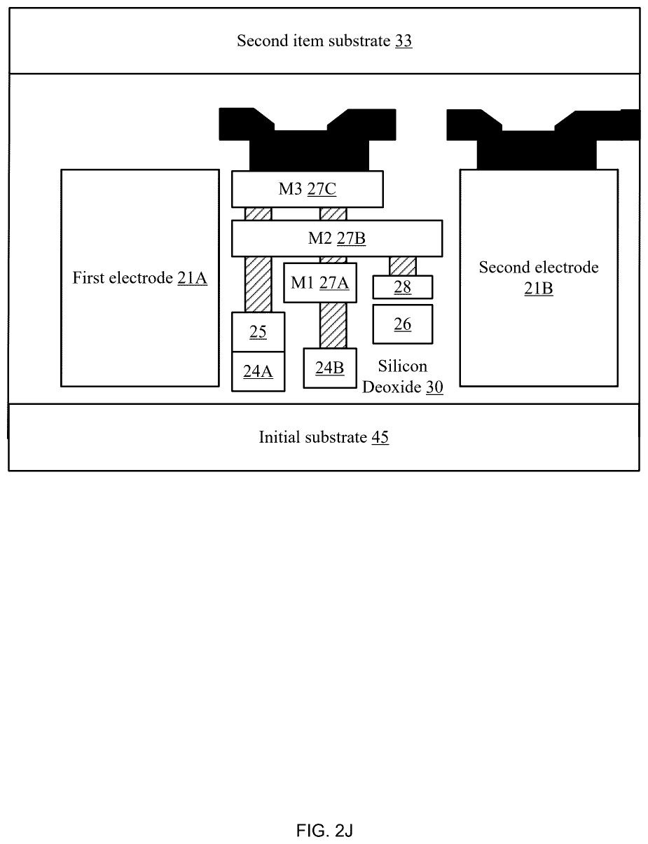

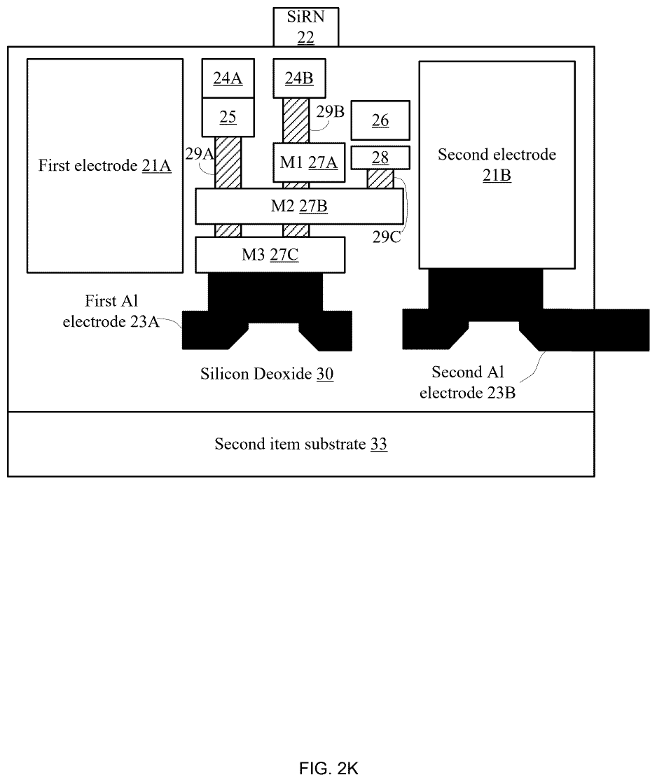

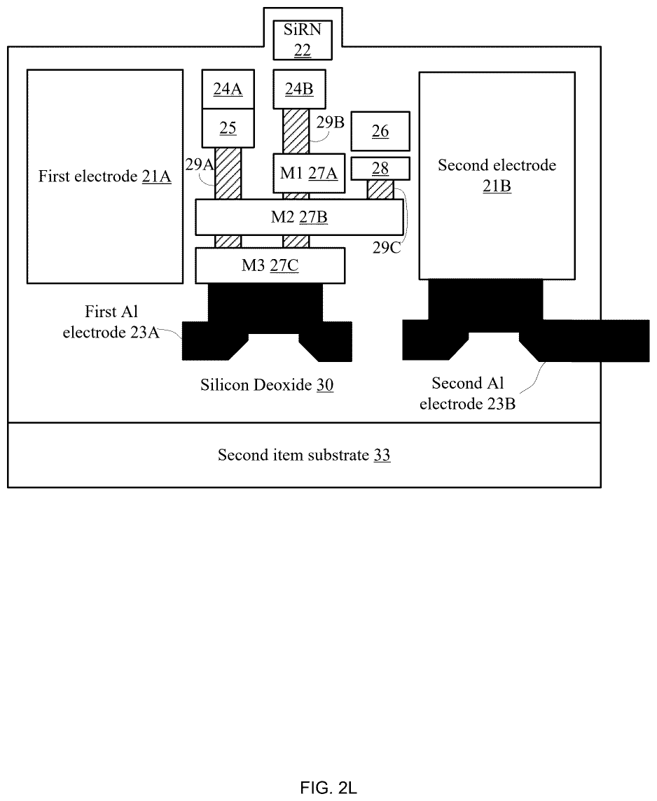

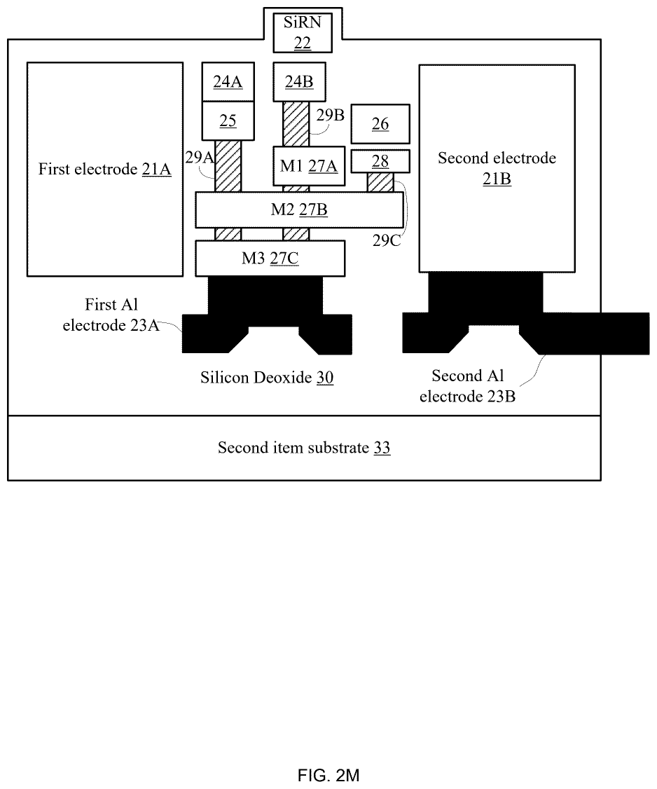

Referring to FIG. 2A, a method for fabricating an electro-optical device may comprise providing a CMOS compliant structure including the first electrode 21A and the second electrode 21B spaced apart from each other within a silicon dioxide region. FIG. 2A illustrates a cross-sectional view of the CMOS compliant second sub-item 20A positioned on an initial substrate 45. The initial substrate 45 may provide a foundation for the fabrication process. The CMOS compliant second sub-item 20A may be manufactured by a CMP (chemical mechanical planarization) manufacturing process.

With continued reference to FIG. 2A, the CMOS compliant second sub-item 20A may include multiple functional regions embedded within the silicon dioxide 30.

The first silicon region 24A and the second silicon region 24B may be positioned adjacent to each other on the initial substrate 45. The germanium region 25 may be located above and between portions of the first silicon region 24A and the second silicon region 24B. The SiN region 26 may be positioned to one side within the silicon dioxide 30. The TiN region 28 may be situated in proximity to the first metal layer region 27A.

As further shown in FIG. 2A, the CMOS compliant second sub-item 20A may incorporate a multi-level metal interconnect system. The first metal layer region 27A, which may be labeled M1, may be positioned at a first level. The second metal layer region 27B, which may be labeled M2, may be positioned above the first metal layer region 27A. The third metal layer region 27C, which may be labeled M3, may be positioned above the second metal layer region 27B. The first metal layer region 27A, the second metal layer region 27B, and the third metal layer region 27C may be arranged in ascending vertical order within the silicon dioxide 30.

With continued reference to FIG. 2A, electrical connectivity between the various layers may be provided by the first via 29A, the second via 29B, and the third via 29C. The first via 29A may extend vertically along one side of the structure, connecting lower regions to upper metal layers. The second via 29B may provide connection between the first metal layer region 27A and lower components including the TiN region 28. The third via 29C may extend along an opposite side of the structure, providing vertical electrical pathways. The silicon dioxide 30 may serve as a dielectric material surrounding and isolating the various functional regions and metal interconnects throughout the structure. The arrangement of the first silicon region 24A, the second silicon region 24B, the germanium region 25, the SiN region 26, the TiN region 28, the first metal layer region 27A, the second metal layer region 27B, the third metal layer region 27C, the first via 29A, the second via 29B, and the third via 29C within the silicon dioxide 30 may represent an initial stage in the fabrication process where CMOS-compliant components are formed prior to subsequent processing steps.

Referring to FIG. 2B, a first phase of the method for fabricating the electro-optical device may comprise depositing a patterned CMP stop layer on a silicon dioxide layer. FIG. 2B illustrates a cross-sectional view of a semiconductor structure during the first phase of the manufacturing process. The structure may include the initial substrate 45 positioned at a bottom of the structure, providing a foundation for the fabrication.

Above the initial substrate 45, the silicon dioxide 30 may encapsulate various components of the structure.

With continued reference to FIG. 2B, within the silicon dioxide 30, the first silicon region 24A and the second silicon region 24B may be positioned adjacent to each other near a lower portion of the silicon dioxide 30. The germanium region 25 may be located above the first silicon region 24A, while the SiN region 26 may be positioned above the second silicon region 24B. The TiN region 28 may be situated above the germanium region 25 and may extend vertically through a portion of the structure.

As further shown in FIG. 2B, the structure may include multiple metal layer regions arranged in a stacked configuration. The first metal layer region 27A, which may be designated as M1, may be positioned above the TiN region 28. The second metal layer region 27B, which may be designated as M2, may be located above the first metal layer region 27A. The third metal layer region 27C, which may be designated as M3, may be positioned at an uppermost level of the metal stack.

With continued reference to FIG. 2B, at a top of the structure, a patterned CMP stop 48 may be formed. The patterned CMP stop 48 may be made of SiN. The patterned CMP stop 48 may define openings that create a first inner space 46A on one side and a second inner space 46B on an opposite side. The first inner space 46A and the second inner space 46B may extend downward into the silicon dioxide 30, flanking a central region containing the metal layer regions.

The first phase may include a sequence of operations. The sequence may comprise CMP stop layer deposition, which may deposit a SiN layer on the silicon dioxide 30. The sequence may further comprise patterning the CMP stop layer to provide the patterned CMP stop 48. The sequence may then comprise SiN etching and oxide etching to provide the first inner space 46A and the second inner space 46B. Etching the silicon dioxide layer may form the first inner space 46A and the second inner space 46B. The patterned CMP stop 48 may serve as a barrier layer during subsequent chemical mechanical planarization processes. The first inner space 46A and the second inner space 46B may provide areas for electrode formation in later manufacturing stages.

Referring to FIG. 2C, a second phase of the method for fabricating the electro-optical device may comprise forming the first electrode 21A and the second electrode 21B. FIG. 2C illustrates a cross-sectional view of the semiconductor structure during the second fabrication phase showing the formation of the first electrode 21A and the second electrode 21B. The structure may include the initial substrate 45 positioned at a bottom of the structure, which may provide a foundation for the device. Above the initial substrate 45, the silicon dioxide 30 may encapsulate various components of the structure.

With continued reference to FIG. 2C, the second phase may comprise depositing copper to form the first electrode 21A in the first inner space 46A and the second electrode 21B in the second inner space 46B. The first electrode 21A and the second electrode 21B may be formed on opposite sides of the structure, extending vertically through the silicon dioxide 30. The copper deposition may fill the first inner space 46A and the second inner space 46B to create the first electrode 21A and the second electrode 21B.

As further shown in FIG. 2C, the second phase may include seed/barrier deposition related to a layer that includes the first silicon region 24A and the second silicon region 24B. The seed/barrier deposition may be performed prior to the copper deposition to promote adhesion and prevent diffusion of copper into surrounding materials. The seed/barrier deposition may provide an interface between the copper electrodes and the silicon dioxide 30.

With continued reference to FIG. 2C, the first electrode 21A and the second electrode 21B may be formed by deposition followed by planarization of the electrodes. The planarization may remove excess copper material from a top surface of the structure. The patterned CMP stop 48 may be positioned at a top surface of the structure, spanning across an upper portion and providing a stop layer for chemical mechanical planarization processes. The patterned CMP stop 48 may define boundaries for the electrode formation and may help control the planarization process during fabrication. The planarization may result in the first electrode 21A and the second electrode 21B having a planar upper surface that is coplanar with the patterned CMP stop 48.

Referring to FIG. 2D, a third phase of the method for fabricating the electro-optical device may comprise removing the patterned CMP stop layer. FIG. 2D illustrates a cross-sectional view of the semiconductor structure after the patterned CMP stop layer has been removed from the structure. The removal of the patterned CMP stop layer may expose an underlying silicon dioxide 30 surface with the first electrode 21A and the second electrode 21B in place.

With continued reference to FIG. 2D, the structure may include the initial substrate 45 positioned at a bottom of the structure. Above the initial substrate 45, the silicon dioxide 30 may encapsulate various components of the structure. The first electrode 21A may be positioned on a left side of the structure, and the second electrode 21B may be positioned on a right side of the structure. The first electrode 21A and the second electrode 21B may extend vertically through the silicon dioxide 30.

As further shown in FIG. 2D, the first silicon region 24A and the second silicon region 24B may be positioned at a lower level within the silicon dioxide 30. The germanium region 25 may be located above the first silicon region 24A, while the SiN region 26 may be positioned above the second silicon region 24B. The TiN region 28 may be situated between and slightly above the germanium region 25 and the SiN region 26.

With continued reference to FIG. 2D, the structure may include multiple metal layer regions arranged in a vertical stack. The first metal layer region 27A, which may be labeled M1, may be positioned above the germanium region 25. The second metal layer region 27B, which may be labeled M2, may be positioned above the first metal layer region 27A. The third metal layer region 27C, which may be labeled M3, may be positioned at an uppermost level of the metal stack. The metal layer regions may be interconnected through vias represented by hatched patterns between the layers.

The removal of the patterned CMP stop layer may be performed after the planarization of the first electrode 21A and the second electrode 21B. The removal may expose a planar upper surface of the silicon dioxide 30 with the first electrode 21A and the second electrode 21B extending to the upper surface. The third phase may prepare the structure for subsequent processing steps including oxide deposition for encapsulation of the electrode material.

Referring to FIG. 2E, a fourth phase of the method for fabricating the electro-optical device may comprise depositing an oxide layer to encapsulate the first electrode and the second electrode. FIG. 2E illustrates a cross-sectional view of the semiconductor structure during the fourth fabrication phase showing oxide deposition for encapsulation of the electrode material and the third metal layer region.

With continued reference to FIG. 2E, the oxide deposition may encapsulate the copper material of the first electrode and the second electrode. The oxide deposition may also encapsulate the third metal layer region. The deposited oxide layer may provide protection and electrical isolation for the first electrode and the second electrode within the structure. The oxide layer may comprise silicon dioxide and may be deposited over the planar upper surface of the structure following removal of the patterned CMP stop layer.

As further shown in FIG. 2E, the fourth phase may further comprise oxide patterning including an oxide etch to reveal an underlying third metal layer region and the second electrode. The oxide patterning may create openings in the deposited oxide layer that expose portions of the third metal layer region and the second electrode. The oxide etch may selectively remove oxide material while leaving the underlying metal regions intact.

With continued reference to FIG. 2E, the oxide patterning may enable subsequent electrical connections to be made to the third metal layer region and the second electrode. The openings created by the oxide etch may provide access points for formation of aluminum electrodes in later fabrication stages. The encapsulation of the first electrode and the second electrode with the oxide layer may prevent oxidation and contamination of the copper electrode material while the oxide patterning may maintain electrical accessibility to selected regions of the structure.

Referring to FIG. 2F, a fifth phase of the method for fabricating the electro-optical device may comprise forming a metal layer such as aluminum. FIG. 2F illustrates a cross-sectional view of the semiconductor structure during the fifth fabrication phase showing the formation of the metal layer. The metal layer may be deposited over the structure following the oxide patterning of the fourth phase. The metal layer deposition may cover the exposed portions of the third metal layer region and the second electrode that were revealed during the oxide etch.

With continued reference to FIG. 2F, the metal layer may comprise aluminum. The aluminum deposition may form a continuous layer over the upper surface of the structure. The aluminum layer may fill the openings created during the oxide patterning and may make electrical contact with the underlying third metal layer region and the second electrode. The aluminum layer may also make electrical contact with the first electrode through the openings in the oxide layer.

As further shown in FIG. 2F, a sixth phase of the method for fabricating the electro-optical device may comprise patterning the metal layer to form spaced apart electrodes. The patterning of the metal layer may form a first aluminum electrode electrically coupled to the first electrode and a second aluminum electrode electrically coupled to the second electrode. The patterning may remove portions of the aluminum layer to create separation between the first aluminum electrode and the second aluminum electrode.

With continued reference to FIG. 2F, the patterning of the metal layer may also form a third aluminum electrode. The third aluminum electrode may be located outside an area of the cross-sectional view shown in FIG. 2F. The third aluminum electrode may provide an additional electrical connection point for the electro-optical device. The spaced apart aluminum electrodes may enable external electrical connections to be made to the first electrode and the second electrode through the first aluminum electrode and the second aluminum electrode, respectively. The aluminum electrodes may be positioned at a bottom portion of the second item following subsequent fabrication steps that flip the structure.

Referring to FIG. 2G, a seventh phase of the method for fabricating the electro-optical device may comprise forming a top oxide layer. The top oxide layer may be formed by clad oxide deposition. The clad oxide deposition may deposit a layer of oxide material over the upper surface of the structure following the patterning of the aluminum electrodes. The top oxide layer may cover the first aluminum electrode, the second aluminum electrode, and exposed portions of the underlying silicon dioxide layer.

With continued reference to FIG. 2G, the top oxide layer may comprise silicon dioxide. The clad oxide deposition may provide a conformal coating over the structure that fills gaps and covers surface topography created by the patterned aluminum electrodes. The top oxide layer may encapsulate the aluminum electrodes and may provide electrical isolation and protection for the underlying components.

As further shown in FIG. 2G, an eighth phase of the method for fabricating the electro-optical device may comprise planarizing the top oxide layer. The planarization may prepare the surface for subsequent processing steps. The planarization may be performed using a chemical mechanical planarization process that removes excess oxide material and creates a planar upper surface.

With continued reference to FIG. 2G, the planarization of the top oxide layer may result in a flat upper surface suitable for bonding operations. The planar upper surface may facilitate bonding of a second item substrate to the structure in subsequent fabrication phases. The planarization may remove surface irregularities and may provide a uniform surface finish across the structure. The planarized top oxide layer may become part of the silicon dioxide region of the second item following completion of the fabrication process.

Referring to FIG. 2H, a ninth phase of the method for fabricating the electro-optical device may comprise bonding a second item substrate to an upper surface of the oxide layer. The second item substrate may be bonded to the planarized upper surface of the top oxide layer that was prepared during the eighth phase. The top oxide layer may be part of a silicon dioxide region of the second item.

With continued reference to FIG. 2H, the second item substrate may comprise a high resistance silicon substrate. The high resistance silicon substrate may provide mechanical support for the structure during subsequent fabrication steps. The bonding of the second item substrate to the upper surface of the oxide layer may be performed using wafer bonding techniques. The bonding may create a permanent attachment between the second item substrate and the silicon dioxide region.

As further shown in FIG. 2H, the bonding of the second item substrate may prepare the structure for subsequent processing steps including flipping the structure and removing an initial substrate. The second item substrate may serve as a handling substrate during the flipping operation and may become a bottom substrate of the second item in the completed electro-optical device. The high resistance silicon substrate may provide electrical isolation and may reduce RF losses during operation of the electro-optical device.

Referring to FIG. 2I, a tenth phase of the method for fabricating the electro-optical device may comprise flipping the CMOS compliant structure and removing an initial substrate from the CMOS compliant structure prior to forming the silicon-rich nitride waveguide. FIG. 2I illustrates a cross-sectional view of the semiconductor structure after the structure has been flipped upside down and the initial substrate has been removed.

With continued reference to FIG. 2I, the flipping of the CMOS compliant structure may reorient the structure such that the second item substrate that was bonded during the ninth phase is now positioned at a bottom of the structure. The flipping operation may invert the vertical arrangement of the components within the structure.

Following the flipping operation, the initial substrate may be positioned at a top of the structure and may be accessible for removal.

As further shown in FIG. 2I, the removal of the initial substrate from the CMOS compliant structure may be performed after the flipping operation. The removal of the initial substrate may expose an underlying surface of the silicon dioxide region.

The removal of the initial substrate may be performed using techniques such as grinding, etching, or a combination of grinding and etching. The removal of the initial substrate may prepare the structure for subsequent formation of the silicon-rich nitride waveguide on the exposed surface.

With continued reference to FIG. 2I, the removal of the initial substrate prior to forming the silicon-rich nitride waveguide may enable the silicon-rich nitride waveguide to be formed on a surface that was previously adjacent to the initial substrate. The exposed surface following removal of the initial substrate may provide a suitable foundation for deposition and patterning of the silicon-rich nitride material. The tenth phase may position the structure in an orientation where the first electrode and the second electrode are located below the surface on which the silicon-rich nitride waveguide will be formed, thereby enabling the silicon-rich nitride waveguide to be positioned between the first electrode and the second electrode in the completed electro-optical device.

Referring to FIG. 2J, an eleventh phase of the method for fabricating the electro-optical device may comprise a substrate bonding stage. FIG. 2J illustrates a cross-sectional view of the second item during a manufacturing stage where the second item substrate has been bonded to the structure. The second item substrate may be positioned at a bottom of the structure, providing support for the overlying components.

With continued reference to FIG. 2J, the structure may include the first electrode and the second electrode positioned within the silicon dioxide region. The first electrode may be located on one side of the structure, and the second electrode may be located on an opposite side of the structure. The first electrode and the second electrode may extend vertically through the silicon dioxide region and may be spaced apart from each other.

As further shown in FIG. 2J, the silicon dioxide region may encapsulate various components of the structure between the second item substrate and an upper surface of the structure. The first silicon region and the second silicon region may be positioned adjacent to each other near an upper portion of the silicon dioxide region. The germanium region may be located above the first silicon region, while the silicon nitride region may be positioned above the second silicon region. The titanium nitride region may be situated above the germanium region.

With continued reference to FIG. 2J, the structure may include multiple metal layer regions arranged in a stacked configuration within the silicon dioxide region. The first metal layer region may be positioned above the titanium nitride region. The second metal layer region may be positioned above the first metal layer region. The third metal layer region may be positioned above the second metal layer region. The metal layer regions may be interconnected through vias that provide electrical connectivity between the different metal levels.

The bonding of the second item substrate to the structure may position the second item substrate at a bottom of the second item in the completed electro-optical device. The second item substrate may comprise a high resistance silicon substrate that may provide mechanical support and electrical isolation for the structure. The eleventh phase may prepare the structure for subsequent formation of the silicon-rich nitride waveguide on an upper surface of the silicon dioxide region. The arrangement of the first electrode and the second electrode within the silicon dioxide region may enable the silicon-rich nitride waveguide to be positioned between the first electrode and the second electrode in later fabrication stages.

Referring to FIG. 2K, a twelfth phase of the method for fabricating the electro-optical device may comprise forming a silicon-rich nitride waveguide on the silicon dioxide region between the first electrode and the second electrode. FIG. 2K illustrates a cross-sectional view of the second item structure showing the arrangement of the SiRN waveguide 22 positioned at a top of the structure above the silicon dioxide 30 and between the first electrode 21A and the second electrode 21B.

With continued reference to FIG. 2K, forming the silicon-rich nitride waveguide may comprise depositing a silicon-rich nitride layer and patterning and etching the silicon-rich nitride layer. The silicon-rich nitride layer may be deposited on an upper surface of the silicon dioxide 30 following removal of the initial substrate during the tenth phase. The deposition of the silicon-rich nitride layer may form a continuous layer of silicon-rich nitride material over the exposed surface of the silicon dioxide 30.

As further shown in FIG. 2K, the patterning of the silicon-rich nitride layer may define a shape and location of the SiRN waveguide 22. The patterning may be performed using photolithographic techniques to create a mask pattern over the silicon-rich nitride layer. The etching of the silicon-rich nitride layer may remove portions of the silicon-rich nitride material that are not protected by the mask pattern, thereby forming the SiRN waveguide 22 with a defined cross-sectional profile.

With continued reference to FIG. 2K, the SiRN waveguide 22 may be positioned between the first electrode 21A and the second electrode 21B. The first electrode 21A may be located on one side of the SiRN waveguide 22, and the second electrode 21B may be located on an opposite side of the SiRN waveguide 22. The positioning of the SiRN waveguide 22 between the first electrode 21A and the second electrode 21B may enable an electric field generated between the first electrode 21A and the second electrode 21B to interact with an optical mode propagating through the SiRN waveguide 22.

As further shown in FIG. 2K, the first aluminum electrode 23A and the second aluminum electrode 23B may be positioned at a bottom portion of the structure.

The first aluminum electrode 23A may be electrically coupled to the first electrode 21A, and the second aluminum electrode 23B may be electrically coupled to the second electrode 21B. The first aluminum electrode 23A and the second aluminum electrode 23B may be embedded within the silicon dioxide 30 and may interface with the second item substrate 33. The arrangement of the first aluminum electrode 23A and the second aluminum electrode 23B at the bottom of the structure may enable electrical connection to an external world via a bottom-most metal layer.

With continued reference to FIG. 2K, the structure may include the first via 29A, the second via 29B, and the third via 29C providing electrical connectivity between the various layers. The first via 29A may extend from a region near the first electrode 21A toward the first metal layer region 27A. The second via 29B may connect the first metal layer region 27A to the second metal layer region 27B. The third via 29C may connect the third metal layer region 27C to the second aluminum electrode 23B. The vias may provide vertical electrical pathways through the silicon dioxide 30 that enable electrical signals to be routed between the aluminum electrodes at the bottom of the structure and the first electrode 21A and the second electrode 21B positioned adjacent to the SiRN waveguide 22.

Referring to FIG. 2L, a thirteenth phase of the method for fabricating the electro-optical device may comprise depositing a silicon dioxide layer on top of the SiRN waveguide and the existing silicon dioxide layer. The silicon dioxide layer may be deposited following the formation of the SiRN waveguide during the twelfth phase. The deposition of the silicon dioxide layer may cover the SiRN waveguide and may extend over exposed portions of the existing silicon dioxide layer surrounding the SiRN waveguide.

With continued reference to FIG. 2L, the deposited silicon dioxide layer may encapsulate the SiRN waveguide and may provide protection for the SiRN waveguide during subsequent processing steps. The silicon dioxide layer may be deposited using deposition techniques that provide conformal coverage over the SiRN waveguide and the existing silicon dioxide layer. The deposited silicon dioxide layer may fill regions adjacent to the SiRN waveguide and may create a continuous dielectric layer over the upper surface of the structure.

As further shown in FIG. 2L, the thirteenth phase may further comprise patterning and etching the silicon dioxide layer to expose underlying aluminum metal.

The patterning of the silicon dioxide layer may define openings that correspond to locations of the aluminum electrodes within the structure. The etching of the silicon dioxide layer may remove silicon dioxide material within the defined openings to reveal the underlying aluminum metal.

With continued reference to FIG. 2L, the exposure of the underlying aluminum metal may allow electrical connection between external devices and metal layers on the wafer. The openings created by the patterning and etching may provide access points through which external electrical connections may be made to the aluminum electrodes. The electrical connections may enable external devices to apply electrical signals to the aluminum electrodes, which may in turn be routed through the via structures and metal layer regions to the first electrode and the second electrode positioned adjacent to the SiRN waveguide.

The patterning and etching of the silicon dioxide layer may be performed using photolithographic techniques to define the locations of the openings and selective etching processes to remove the silicon dioxide material while leaving the underlying aluminum metal intact. The exposure of the aluminum metal may enable wire bonding, flip-chip bonding, or other interconnection techniques to be used for establishing electrical connections between the electro-optical device and external circuitry.

Referring to FIG. 2M, a completed second item structure may be ready for bonding following the fabrication phases described above. FIG. 2M illustrates a cross-sectional view of the second item structure showing the internal arrangement of various components within a silicon dioxide 30 region positioned above a second item substrate 33. The SiRN waveguide 22 may be positioned at a top center of the structure. Below the SiRN waveguide 22, the structure may contain a first silicon region 24A and a second silicon region 24B positioned on opposite sides. A germanium region 25 may be located adjacent to the first silicon region 24A, while a SiN region 26 may be positioned adjacent to the second silicon region 24B. A TiN region 28 may be situated below the SiN region 26.

With continued reference to FIG. 2M, the structure may include multiple metal layer regions arranged vertically, with a first metal layer region 27A, a second metal layer region 27B, and a third metal layer region 27C. The metal layer regions may be interconnected through a first via 29A, a second via 29B, and a third via 29C, which may provide electrical connectivity between the different layers. A first electrode 21A may be positioned on one side of the structure, and a second electrode 21B may be positioned on an opposite side of the structure, with both electrodes extending vertically through the silicon dioxide 30.

As further shown in FIG. 2M, at a bottom of the structure, a first aluminum electrode 23A may connect to the first electrode 21A, and a second aluminum electrode 23B may connect to the second electrode 21B. The first aluminum electrode 23A and the second aluminum electrode 23B may be embedded within the silicon dioxide 30 and may interface with the second item substrate 33. The arrangement may facilitate electrical connections between the silicon regions, metal layers, and external electrodes while maintaining structural integrity provided by the silicon dioxide 30 encapsulation.

With continued reference to FIG. 2M, planarizing a top of the silicon dioxide 30 may prepare the structure for bonding. The planarization may create a planar upper surface suitable for receiving a first item including a lithium niobate layer. The planar upper surface may enable direct bonding between the silicon dioxide 30 of the second item and the lithium niobate layer of the first item.

The method for fabricating the electro-optical device may comprise bonding a first item including a lithium niobate layer to the silicon dioxide region such that the lithium niobate layer is positioned adjacent to the silicon-rich nitride waveguide. The bonding of the electrooptically active material, which may be the lithium niobate layer, may be performed as a last step in the fabrication process. Performing the bonding of the lithium niobate layer as the last step may eliminate a need for any post-processing when the active material is attached to a surface of the wafer. The elimination of post-processing requirements may simplify the fabrication process and may reduce potential damage to the lithium niobate layer that could otherwise occur during subsequent processing operations.

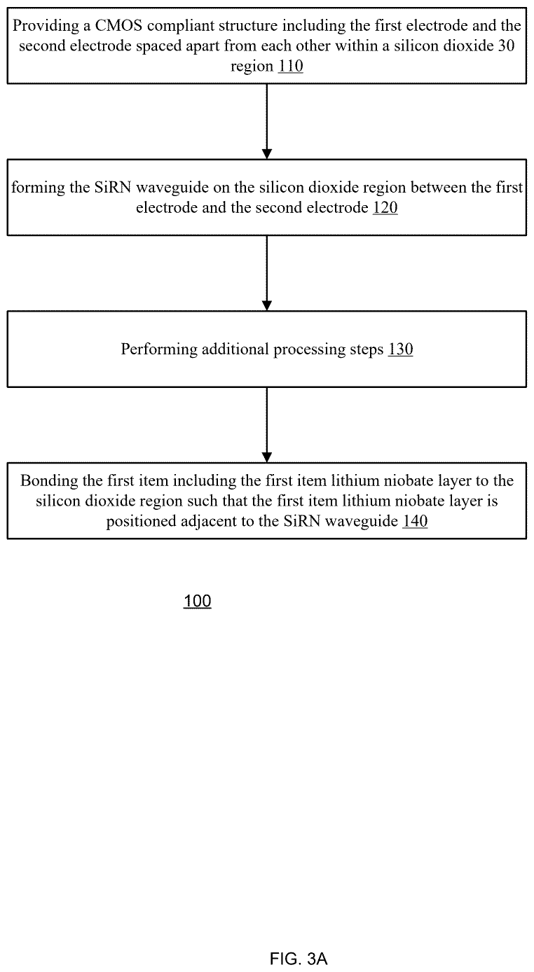

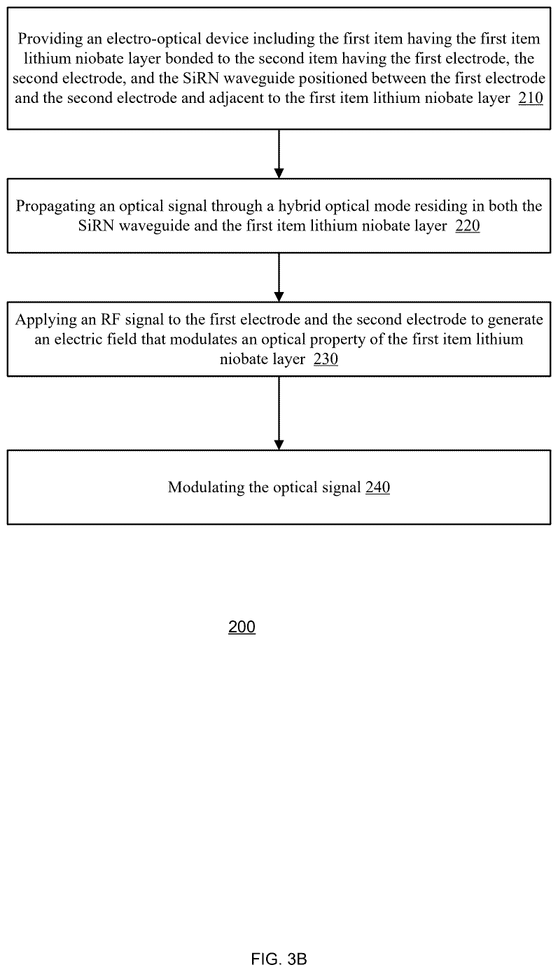

Referring to FIG. 3A, a method 100 for fabricating the electro-optical device may comprise a sequence of steps. The method 100 may begin with a step 110. The method 100 may then proceed to a step 120. Following the step 120, the method 100 may continue to a step 130. The method 100 may then advance to a step 140.

With continued reference to FIG. 3A, the step 110 may comprise providing a CMOS compliant structure including the first electrode 21A and the second electrode 21B spaced apart from each other within the silicon dioxide 30 region. The CMOS compliant structure may be the CMOS compliant second sub-item 20A. The step 110 may include forming the first silicon region 24A, the second silicon region 24B, the germanium region 25, the SiN region 26, the TiN region 28, the first metal layer region 27A, the second metal layer region 27B, and the third metal layer region 27C within the silicon dioxide 30. The step 110 may further include forming the first via 29A, the second via 29B, and the third via 29C to provide electrical connectivity between the various layers. The step 110 may also include forming the first aluminum electrode 23A electrically coupled to the first electrode 21A and the second aluminum electrode 23B electrically coupled to the second electrode 21B.

As further shown in FIG. 3A, the step 120 may comprise forming the SiRN waveguide 22 on the silicon dioxide 30 region between the first electrode 21A and the second electrode 21B. The step 120 may include depositing a silicon-rich nitride layer and patterning and etching the silicon-rich nitride layer to form the SiRN waveguide 22. The SiRN waveguide 22 may be positioned between the first electrode 21A and the second electrode 21B such that an electric field generated between the first electrode 21A and the second electrode 21B may interact with an optical mode propagating through the SiRN waveguide 22.

With continued reference to FIG. 3A, the step 130 may comprise additional processing steps. The step 130 may include depositing a silicon dioxide layer on top of the SiRN waveguide 22 and the existing silicon dioxide 30 layer. The step 130 may further include patterning and etching the silicon dioxide layer to expose underlying aluminum metal to allow electrical connection between external devices and metal layers on the wafer. The step 130 may also include planarizing a top of the silicon dioxide 30 to prepare for bonding.

As further shown in FIG. 3A, the step 140 may comprise bonding the first item 10 including the first item lithium niobate layer 13 to the silicon dioxide 30 region such that the first item lithium niobate layer 13 is positioned adjacent to the SiRN waveguide 22. The bonding of the first item 10 may be performed as a last step in the fabrication process. The first item 10 may further include the first item substrate 11 and the first item BOX layer 12 disposed between the first item substrate 11 and the first item lithium niobate layer 13.

The electro-optical device fabricated according to the method 100 may be a part of a modulator. The modulator may be as illustrated in FIG. 6 of US patent application Ser. No. 18/860,678, titled ELECTCRO-OPTIC MODULATOR AND A METHOD FOR FABRICATING THE ELECTRO-OPTIC MODULATOR, which is incorporated herein by reference. The modulator may utilize the field 40 generated between the first electrode 21A and the second electrode 21B to modulate an optical property of the first item lithium niobate layer 13, thereby modulating an optical signal propagating through a hybrid optical mode residing in both the SiRN waveguide 22 and the first item lithium niobate layer 13.

Referring to FIG. 3B, a method 200 for operating the electro-optical device may comprise a sequence of steps. The method 200 may begin with a step 210. The method 200 may then proceed to a step 220. Following the step 220, the method 200 may continue to a step 230. The method 200 may then advance to a step 240.

With continued reference to FIG. 3B, the step 210 may comprise providing an electro-optical device including the first item 10 having the first item lithium niobate layer 13 bonded to the second item 20 having the first electrode 21A, the second electrode 21B, and the SiRN waveguide 22 positioned between the first electrode 21A and the second electrode 21B and adjacent to the first item lithium niobate layer 13. The first item 10 may further include the first item substrate 11 and the first item BOX layer 12 disposed between the first item substrate 11 and the first item lithium niobate layer 13. The second item 20 may further include the silicon dioxide 30 region surrounding the first electrode 21A, the second electrode 21B, and the SiRN waveguide 22.

As further shown in FIG. 3B, the step 220 may comprise propagating an optical signal through a hybrid optical mode residing in both the SiRN waveguide 22 and the first item lithium niobate layer 13. The SiRN waveguide 22 may be configured to support the hybrid optical mode that resides in both the SiRN waveguide 22 and the first item lithium niobate layer 13. The optical signal may propagate through the hybrid optical mode such that a portion of the optical energy resides within the SiRN waveguide 22, and another portion of the optical energy resides within the first item lithium niobate layer 13.

With continued reference to FIG. 3B, the SiRN waveguide 22 may have a refractive index higher than stoichiometric silicon nitride. The higher refractive index of the SiRN waveguide 22 may provide higher optical confinement compared to stoichiometric silicon nitride waveguides. The higher optical confinement may allow closer positioning of the first electrode 21A and the second electrode 21B to the SiRN waveguide 22 without increasing optical propagation loss. The closer positioning of the first electrode 21A and the second electrode 21B to the SiRN waveguide 22 may enable more efficient electro-optical modulation by increasing the electric field strength at the location of the optical mode.

As further shown in FIG. 3B, the step 230 may comprise applying an RF signal to the first electrode 21A and the second electrode 21B to generate an electric field that modulates an optical property of the first item lithium niobate layer 13. The RF signal may be applied to the first electrode 21A and the second electrode 21B to generate the field 40 between the first electrode 21A and the second electrode 21B. The field 40 may interact with the first item lithium niobate layer 13 and may modulate an optical property of the first item lithium niobate layer 13 through the electro-optic effect.

With continued reference to FIG. 3B, the second item 20 may further comprise the first aluminum electrode 23A electrically coupled to the first electrode 21A and the second aluminum electrode 23B electrically coupled to the second electrode 21B. The RF signal may be applied through the first aluminum electrode 23A and the second aluminum electrode 23B. The first aluminum electrode 23A and the second aluminum electrode 23B may be positioned at a bottom portion of the second item 20. The positioning of the first aluminum electrode 23A and the second aluminum electrode 23B at the bottom portion of the second item 20 may enable electrical connection to an external world via a bottom-most metal layer, which may ease a requirement for top oxide planarization before bonding.

As further shown in FIG. 3B, the step 240 may comprise modulating the optical signal. The modulation of the optical property of the first item lithium niobate layer 13 by the field 40 may result in modulation of the optical signal propagating through the hybrid optical mode. The modulation may change a phase, amplitude, or other characteristic of the optical signal in response to the RF signal applied to the first electrode 21A and the second electrode 21B. The electro-optical device may thereby function as an optical modulator that converts an electrical RF signal into a modulated optical signal.

A number of implementations have been described. Nevertheless, it will be understood that various modifications may be made without departing from the spirit and scope of the disclosure. Accordingly, other implementations are within the scope of the following claims.

The electro-optical device described herein may provide several technical benefits. The use of silicon-rich nitride material for the waveguide may enable a higher refractive index compared to stoichiometric silicon nitride, which may result in stronger optical confinement within the waveguide structure. The stronger optical confinement may permit the first electrode and the second electrode to be positioned in closer proximity to the waveguide without introducing unacceptable levels of optical propagation loss. The closer electrode positioning may increase the electric field strength experienced by the lithium niobate layer at the location of the optical mode, which may improve the efficiency of electro-optical modulation.

The fabrication approach in which the lithium niobate layer is bonded as a final step may provide manufacturing advantages. By positioning the electrooptically active material attachment at the end of the fabrication sequence, post-processing operations that could potentially damage the lithium niobate layer may be avoided. The elimination of post-bonding processing steps may simplify the overall manufacturing flow and may improve device yield.

The arrangement of aluminum electrodes at a bottom portion of the second item may facilitate electrical connections to external circuitry via a bottom-most metal layer. This configuration may reduce requirements for top oxide planarization prior to bonding the first item to the second item. The reduced planarization requirements may simplify the fabrication process and may improve bonding quality between the lithium niobate layer and the silicon dioxide region.

The use of a high resistance silicon substrate for the second item substrate may reduce RF losses during high-frequency operation of the electro-optical device. The reduced RF losses may improve the bandwidth and efficiency of the modulator when operating at high data rates.

In some aspects, the first electrode and the second electrode may comprise copper. In other aspects, the first electrode and the second electrode may comprise alternative conductive materials. The first electrode and the second electrode may comprise tungsten, aluminum, gold, silver, or alloys thereof. In some cases, the first electrode and the second electrode may comprise a combination of materials, such as a copper core with a barrier layer comprising tantalum, tantalum nitride, titanium, or titanium nitride. The selection of electrode material may depend on factors such as electrical conductivity, compatibility with CMOS fabrication processes, and resistance to electromigration.

Any reference to any of the terms “comprise”, “comprises”, “comprising” “including”, “may include” and “includes” may be applied to any of the terms “consists”, “consisting”, “consisting essentially of”. For example-any of the rectifying circuits illustrated in any figure may include more components that those illustrated in the figure, only the components illustrated in the figure or substantially only the components illustrated in the figure.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time.

Moreover, alternative embodiments may include multiple instances of a particular operation, and the order of operations may be altered in various other embodiments.

Also for example, in one embodiment, the illustrated examples may be implemented as circuitry located on a single integrated circuit or within a same device.

Alternatively, the examples may be implemented as any number of separate integrated circuits or separate devices interconnected with each other in a suitable manner.

However, other modifications, variations and alternatives are also possible.

The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe.

Thus, these terms are not necessarily intended to indicate temporal or other prioritization of such elements.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An electro-optical device, comprising:
a first item including a lithium niobate layer; and
a second item bonded to the first item, the second item including:
a first electrode and a second electrode spaced apart from each other;
a silicon-rich nitride waveguide positioned between the first electrode and the second electrode and adjacent to the lithium niobate layer; and
a silicon dioxide region surrounding the first electrode, the second electrode, and the silicon-rich nitride waveguide;
wherein the silicon-rich nitride waveguide is configured to support a hybrid optical mode residing in both the silicon-rich nitride waveguide and the lithium niobate layer, and wherein the first electrode and the second electrode are configured to generate an electric field that modulates an optical property of the lithium niobate layer.

2. The electro-optical device of claim 1, wherein the first electrode and the second electrode comprise copper.

3. The electro-optical device of claim 1, wherein the second item further comprises:
a first aluminum electrode electrically coupled to the first electrode; and
a second aluminum electrode electrically coupled to the second electrode.

4. The electro-optical device of claim 3, wherein the first aluminum electrode and the second aluminum electrode are positioned at a bottom portion of the second item.

5. The electro-optical device of claim 1, wherein the first item further comprises:
a first item substrate; and
a buried oxide layer disposed between the first item substrate and the lithium niobate layer.

6. The electro-optical device of claim 1, wherein the second item further comprises a second item substrate positioned below the silicon dioxide region.

7. The electro-optical device of claim 6, wherein the second item substrate comprises a high resistance silicon substrate.

8. The electro-optical device of claim 1, wherein the second item further comprises a CMOS compliant sub-item disposed within the silicon dioxide region, the CMOS compliant sub-item including:
a first silicon region;
a second silicon region;
a germanium region;
a silicon nitride region;
a titanium nitride region;
a first metal layer region;
a second metal layer region; and
a third metal layer region.

9. The electro-optical device of claim 8, wherein the second item further comprises:
a first via connecting the first electrode to the first metal layer region;
a second via connecting the first metal layer region to the second metal layer region; and
a third via connecting the second metal layer region to the third metal layer region.

10. The electro-optical device of claim 8, wherein the germanium region is configured for optical sensing.

11. The electro-optical device of claim 8, wherein the titanium nitride region is configured as a resistor or a heater.

12. A method for fabricating an electro-optical device, comprising:
providing a CMOS compliant structure including a first electrode and a second electrode spaced apart from each other within a silicon dioxide region;
forming a silicon-rich nitride waveguide on the silicon dioxide region between the first electrode and the second electrode; and
bonding a first item including a lithium niobate layer to the silicon dioxide region such that the lithium niobate layer is positioned adjacent to the silicon-rich nitride waveguide.

13. The method of claim 12, wherein providing the CMOS compliant structure comprises:
depositing a patterned CMP stop layer on a silicon dioxide layer;
etching the silicon dioxide layer to form a first inner space and a second inner space;
depositing copper to form the first electrode in the first inner space and the second electrode in the second inner space; and
removing the patterned CMP stop layer.

14. The method of claim 13, further comprising:
depositing an oxide layer to encapsulate the first electrode and the second electrode;
forming a first aluminum electrode electrically coupled to the first electrode; and
forming a second aluminum electrode electrically coupled to the second electrode.

15. The method of claim 14, further comprising:
bonding a second item substrate to an upper surface of the oxide layer;
flipping the CMOS compliant structure; and
removing an initial substrate from the CMOS compliant structure prior to forming the silicon-rich nitride waveguide.

16. The method of claim 12, wherein forming the silicon-rich nitride waveguide comprises depositing a silicon-rich nitride layer and patterning and etching the silicon-rich nitride layer.

17. A method for operating an electro-optical device, comprising:
providing an electro-optical device including a first item having a lithium niobate layer bonded to a second item having a first electrode, a second electrode, and a silicon-rich nitride waveguide positioned between the first electrode and the second electrode and adjacent to the lithium niobate layer;
propagating an optical signal through a hybrid optical mode residing in both the silicon-rich nitride waveguide and the lithium niobate layer; and
applying an RF signal to the first electrode and the second electrode to generate an electric field that modulates an optical property of the lithium niobate layer, thereby modulating the optical signal.

18. The method of claim 17, wherein the second item further comprises a first aluminum electrode electrically coupled to the first electrode and a second aluminum electrode electrically coupled to the second electrode, and wherein the RF signal is applied through the first aluminum electrode and the second aluminum electrode.

19. The method of claim 18, wherein the first aluminum electrode and the second aluminum electrode are positioned at a bottom portion of the second item.

20. The method of claim 17, wherein the silicon-rich nitride waveguide has a refractive index higher than stoichiometric silicon nitride, thereby providing higher optical confinement and allowing closer positioning of the first electrode and the second electrode to the silicon-rich nitride waveguide without increasing optical propagation loss.
